(19) United States
(12) Patent Application Publication
(10) Pub. No.: US 2014/0378184 A1
(43) Pub. Date: Dec. 25, 2014

(54) MOBILE COMMUNICATIONS DEVICE HAVING A DISTANCE SENSOR AND A METHOD OF MANUFACTURING THE SAME

(71) Applicant: Nvidia Corporation, Santa Clara, CA (US)

(72) Inventor: Sunil Thorat, Pune (IN)

(21) Appl. No.: 13/926,067

(22) Filed: Jun. 25, 2013

(51) Int. Cl. H04M 1/21

(52) U.S. Cl. CPC H04M 1/21
USPC 455/556.1; 29/592.1

(57) ABSTRACT

The disclosure provides a mobile communications device having a distance sensor and a method of manufacturing the same. In one embodiment, the mobile communications device includes: (1) a communications interface configured to transmit and receive data according to a communications protocol, (2) a processor configured to direct communication of the data employing the communications interface and (3) a distance sensor configured to determine a distance between two objects, wherein the processor is further configured to direct operation of the distance sensor.

### TECHNICAL FIELD

This application is directed, in general, to mobile communications devices and, more specifically, to smart phones.

### BACKGROUND

The popularity of mobile telephones continues to increase. All ages, from children to senior adults, can be seen using mobile telephones. Whether they are being used for voice communication or texting, mobile telephones appear to be the preferred instrument for communication. Everyone seems to have one and they seem to have one with them at all times.

### SUMMARY

In one aspect, a mobile communications device is disclosed. In one embodiment, the mobile communications device includes: (1) a communications interface configured to transmit and receive data according to a communications protocol, (2) a processor configured to direct communication of the data employing the communications interface and (3) a distance sensor configured to determine a distance between two objects, wherein the processor is further configured to direct operation of the distance sensor.

In another aspect, a method of manufacturing a mobile communications device is disclosed. In one embodiment, the method of manufacturing includes: (1) connecting at least a portion of a distance sensor to a body of the mobile communications device, (2) connecting at least a portion of a communications interface to the body and (3) connecting the distance sensor and the communications interface to a processor of the mobile communications device.

In yet another aspect a smart phone is disclosed. In one embodiment the smart phone includes: (1) a body, (2) a communications interface connected to the body and (3) a distance sensor connected to the body.

### BRIEF DESCRIPTION

Reference is now made to the following descriptions taken in conjunction with the accompanying drawings, in which:

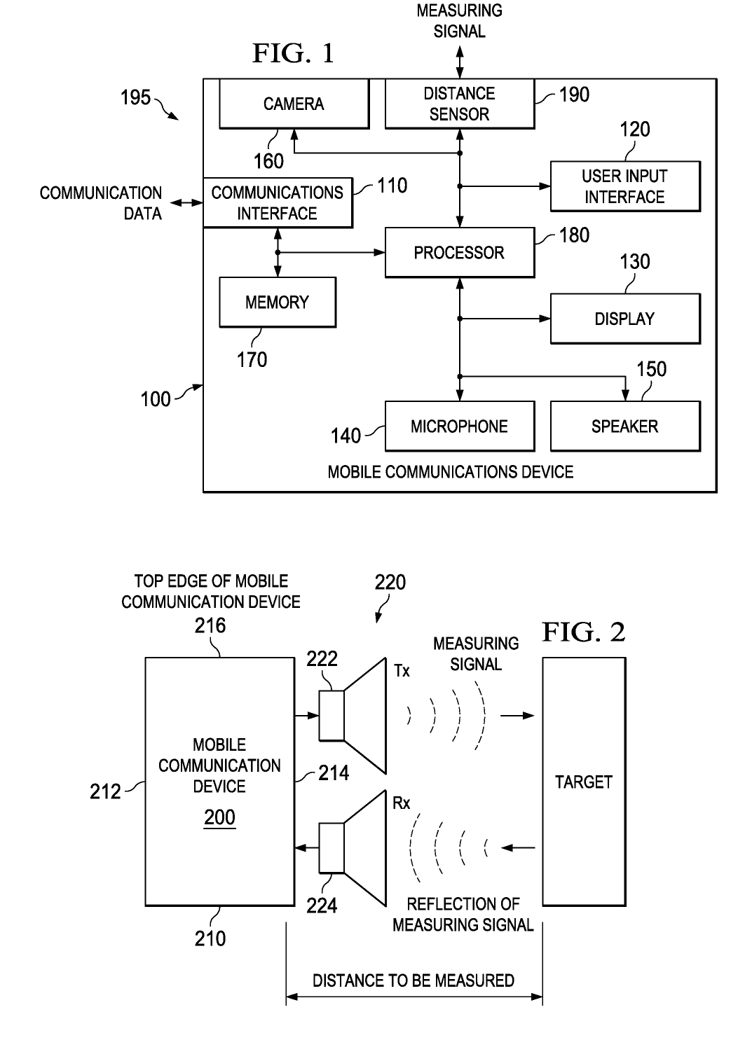

FIG. 1 illustrates a block diagram of an embodiment of a mobile communications device constructed according to the principles of the disclosure;

FIG. 2 illustrates a diagram of an embodiment of a mobile communications device being used to determine a distance to a target according to the principles of the disclosure; and

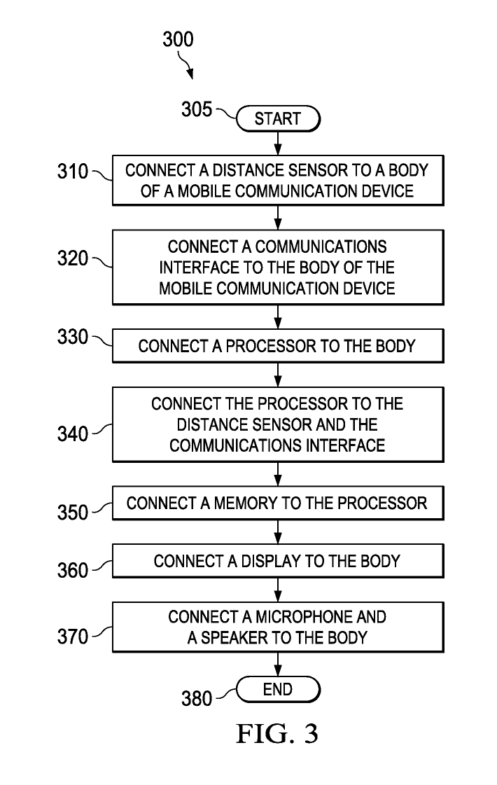

FIG. 3 illustrates a flow diagram of an embodiment of a method of manufacturing a mobile communications device carried out according to the principles of the disclosure.

### DETAILED DESCRIPTION

In contrast to the accessibility of mobile telephones, a measuring tool, such as a tape measure, never seems to be around when needed. The disclosure recognizes the convenience of mobile communications devices and introduces employing these devices as measuring tools. Accordingly, the disclosure provides a mobile communications device that can be used as a distance measuring device. A mobile communications device is a communication device constructed specifically for a mobile architecture that enables portability. A mobile communications device is built on a mobile operating system and includes mobile hardware and software configured to perform communication functions. In some embodiments, a mobile communications device as used herein is at least configured to perform voice communication over a network. In addition to communicating, some mobile communicating devices can include the processing capability to perform additional functions. In one embodiment, the mobile communications device is a smart phone. A smart phone is built on a mobile operating system and has advanced computing capability than a mobile telephone that simply has communication capabilities. In other embodiments, the mobile communications device can be another mobile communications device such as a tablet, a clamshell, a game device, etc.

The disclosure therefore introduces a mobile communications device that includes additional components such that it can also be used as a measuring device. In one embodiment, the disclosure provides a mobile communications device having a distance sensor. The distance sensor can be, for example, a laser sensor or an ultrasonic sensor that employs a transducer to transmit a signal that is used to determine a distance. The mobile communications device also includes a processor that is configured to both direct operation of the distance sensor and perform measurement calculations employing the distance sensor. In addition to the measurement calculations, the processor is also configured to perform communication functions such as voice and/or written communication via a communications interface. Accordingly, in one embodiment a mobile communications device is disclosed that includes a processor configured to provide communication functions and measurement functions. A measurement application can be stored on a memory of the mobile communications device and used to direct the measurement calculations and operation of the distance sensor. The measurement application can also be used to provide a user interface for the mobile communications device.

The measurement application can cooperate with the distance sensor to populate measurements into a map or layout of an area. In some embodiments, the measurement application can cooperate with another application to fill in measurements for a particular area. The measurement application can also employ distances determined by the distance sensor in geometric calculations to determine geometric parameters such as an area and a volume.

Thus, the disclosure recognizes that dedicated measuring devices, such as a ruler or tape measure, are not always readily available for making measurements. Accordingly, the disclosure provides a non-dedicated measuring tool, a mobile communications device, that is more accessible for a user to use to take measurements. Additionally, an individual can use the disclosed mobile communications device to make measurements without the assistance of another person. This is advantageous when measuring a distance greater than, for example, five feet. Furthermore, the disclosed mobile communications device makes it easier for an individual to take measurements such as the depth of a tank or the aerial distance between two objects compared to using conventional dedicated measuring tools, such as a tape measure or a ruler.

FIG. 1 illustrates a block diagram of an embodiment of a mobile communications device 100 constructed according to the principles of the disclosure. The mobile communications device 100 includes a communications interface 110, a user input interface 120, a display 130, a microphone 140, a speaker 150, a camera 160, a memory 170, a processor 180 and a distance sensor 190. The noted components or at least a portion of the noted components of the mobile communications device 100 are located within a body 195. The body 195 is constructed of a rigid material and is constructed to protect the components of the mobile computing device 100. One skilled in the art will understand that the mobile communications device 100 also includes additional components, such as a battery/power supply, that are not illustrated but are typically included in a conventional mobile communications device.

The communications interface 110 includes the necessary circuitry, components and logic to communicate via wireless or wired connections employing standard communication protocols. As such, the communications interface 110 is configured to communicate employing at least one networking protocol such as Ethernet, Wi-Fi, Internet or cellular network protocols. The communications interface 110 includes an antenna for communicating over a radio link. In one embodiment, the communications interface 110 is a communications interface of a smart phone. In some embodiments, the communications interface 110 can also include a port or connector for wired communication.

The user input interface 120 is configured to receive input from a user. The user input interface 120 can be a keyboard, a keypad, a touchpad, etc. In some embodiments, the display 130 or a portion thereof can be used as the user interface 120. Input received by the user input interface 120 can be used to direct operation of the distance sensor 190. In some embodiments, input for directing the distance sensor 190 can also be received via the microphone 140. The user input interface 120 can also provide a visual output indicating operation of the distance sensor 190. The output can include measurements and requests for input to operate the distance sensor 190 (e.g., mode to use, which side of the body 195 is the distance sensor 190 on, store measurement values, etc.). In some embodiments, the speaker 150 can be used to provide an audio output. The processor 180 can be used with the user input interface 120, the microphone 140 and the speaker 150, to control the distance sensor 190.

The display 130 is configured to provide a visual representation of data. The microphone 140 and the speaker 150 are configured to receive audio input and deliver audio output, respectively. The camera 160 is configured to take pictures. In one embodiment, the camera can take still pictures and video. The communications interface 110, the user input interface 120, the display 130, the microphone 140, the speaker 150 and the camera 160 can be conventional components of a mobile communications device. For example, in one embodiment the communications interface 110, the user input interface 120, the display 130, the microphone 140, the speaker 150 and the camera 160 are conventional components of a smart phone.

The memory 170 is configured to store data for the mobile communications device 100, including operating instructions that direct the operation of the mobile communications device 100 when initiated. The memory 170 can be a conventional memory typically located within a mobile communications device that is constructed to store data and computer programs or applications. For example, the memory 170 can be a RAM or a ROM that is employable for or designed to operate in mobile communications devices. In one embodiment, the memory 170 is a ROM that can be modified by system updates.

In contrast to conventional mobile communications devices, in some embodiments the memory 170 is also configured to store measurement applications to execute on the mobile communications device 100. The measurement applications are configured to direct operation of the distance sensor 190. In some embodiments, the measurement application is configured to employ the distance sensor to determine multiple distances. The multiple distances can be used in geometric calculations to determine geometric parameters, such as area or volume of a space. Thus, in addition to operating instructions for mobile communication, the memory 170 can also store operating instructions that correspond to algorithms that provide the measurement functionality disclosed herein; such as to perform the method of measuring discussed with respect to FIG. 2. The measurement applications can be loaded into the memory during manufacturing of the mobile communications device 100. In some embodiments, a measurement application or upgraded application can be obtained after manufacturing via a download, such as from an application store.

The processor 180 is configured to direct operation of the mobile communications device 100. In one embodiment, the processor 180 may be a conventional processor used in mobile communications devices, such as a TEGRA processor from Nvidia Corporation of Santa Clara, Calif. The processor 180 is configured to direct communication of data via the communications interface 110. Additionally, the processor 180 is configured to direct operation of the distance sensor 190. The processor is located within the body 195 of the mobile communications device 100 and is connected to the various illustrated components thereof via conventional means.

The distance sensor 190 is configured to determine a distance to a target. In some embodiments, the distance sensor 190 is configured to transmit a signal and determine a distance based on receiving a reflection of the signal. In one embodiment, the distance sensor 190 is a laser sensor that uses time of flight principle of distance measurement. The laser sensor includes an originating laser transducer (e.g., a transmitter) which transmits laser beam towards the target object and which is received by a terminating laser transducer (e.g., a receiver) after reflection. Accordingly, in one embodiment the distance sensor 190 is a laser sensor that includes a pair of transmitter-receiver sensors. In another embodiment, the distance sensor 190 is an ultrasonic sensor. The ultrasonic sensor can also have an originating and a terminating transducer.

In some embodiments, the distance sensor 190 is positioned close to an edge, top or bottom, of the mobile communications device 100 to increase the accuracy of the measurement. In one embodiment, the distance sensor 190 is located proximate to the camera 160 of the mobile communications device 100 to insure that the distance sensor 190 is located within an opening of a conventional cover for the mobile communications device 100. As such, the distance sensor 190 can be used when a cover is being used with the mobile communications device 180. A cover is designed to fit around the body 195 of the mobile communications device 100 to provide additional protection and/or decoration. In one embodiment, the distance sensor 190 is located on an opposite side of the body 195 than the user input interface 110 and the display 120. Depending on a particular user, this allows a user to operate the distance sensor 190 while also viewing an output of the measurement from the distance sensor 190. In other embodiments, the distance sensor 190 is located on the same side of the body 195 than the user input interface 110 and the display 120. Depending on the embodiment, the mobile communications device 100 can be configured to allow a user to select which side of the body 195 to be used for determining a distance. In one embodiment, the mobile communications device 100 can automatically select from which side to transmit the measuring signal based on, for example, reflection of the transmitted measuring signal.

In some embodiments, the processor 180 is configured to compensate for thickness of the mobile communications device 100 when taking a measurement. The mobile communications device 100 can receive a user input from either the user input interface 120 or the microphone 140 to indicate if a thickness offset is needed. This can also be determined automatically similarly to automatically determining which side to transmit the measuring signal. In some embodiments, the distance sensor 190 can be located on a thin side of the mobile communications device 100 and compensation for the width of the mobile communications device 100 can be used when determining measurements.

FIG. 2 illustrates a diagram of an embodiment of a mobile communications device 200 being used to determine a distance to a target according to the principles of the disclosure. The mobile communications device 200 can be the mobile communications device 100 of FIG. 1. As such, the mobile communications device 200 can include at least the same components as those illustrated and discussed with respect to FIG. 1. In FIG. 2, a body 210 and a distance sensor 220 of the mobile communications device 200 are denoted.

The body 210 has a front side 212, a back side 214 and a thin side 216. The front side 212 of the body 210 includes a display and a user input interface (not shown). The back side 214, which is the opposite side of the body 210 compared to the front side 212, is where the distance sensor 220 is located. In some embodiments, the distance sensor 220 is located on the thin side and a processor of the mobile communications device 200 compensates for the width (across the front and/or back side 212, 214) of the mobile communications device 200.

The distance sensor 220 includes an originating transducer 222 and a terminating transducer 224. In FIG. 2, the originating and terminating transducers 222, 224, are shown to be extended from the back side 214 for illustrative purposes. Typically, the originating and terminating transducers 222, 224, are flush or at least substantially flush with a side of the mobile communications device 200, such as the back side 214.

The distance sensor 220 is configured to determine a distance to a target. Considering the mobile communications device 200, the distance is between two objects; the mobile communications device 200 and the target. As such, the mobile communications device is positioned at a first location to determine a distance between the first location to the target. The distance sensor 220 can be an ultrasonic sensor or another type of sensor that generates a signal and employs that signal to determine a distance. For ease of explanation, the distance sensor 220 is a laser sensor. As such, the originating transducer and the terminating transducer 222, 224, are both laser transducers and will be referred to as such hereafter. Though various distance sensors can be used, a laser sensor provides the advantage of being visibly seen and will help to exactly locate the point from where the distance is measured.

To obtain a measurement, the mobile communications device 200 is positioned at a location of interest with the back side 214 facing the target. The distance between the location of interest and the target is the distance to be determined. The location of interest can be an object or a point in space.

The originating laser transducer 222 generates and transmits a signal that is reflected by the target. An initiation signal can be generated by the processor of the mobile communications device 200 in response to a received user input. The terminating laser transducer 224 detects and receives the reflected signal from the target. The time delay of the transmitted and the received signal corresponds to the distance between the mobile communications device 200 and the target. A processor of the mobile communications device 200 can calculate the distance based on the time delay. In some embodiments, the distance sensor 220 includes the necessary circuitry and logic to determine the distance based on a reflected signal that is received by the terminating laser transducer 224. The terminating laser transducer 224 and the original laser transducer 222 can be conventional laser transducers.

In some embodiments, the originating and terminating laser sensors 222, 224, can be employed with a phase shift method or frequency modulation method to determine the distance. The processor of the mobile communications device 200 can be configured to perform the necessary calculations employing either of these methods. The type of method used can depend on the desired accuracy and/or the range of the distance. In some embodiments, multiple methods may be used to determine the distance for increased accuracy. An average of the various methods can be used to determine to distance. A user may select which method to use via the user input interface. A measurement application can be employed to automatically select which method is appropriate based on, for example, distance.

Various methods of employing the mobile communications device 200 for determining distances will now be presented. In one embodiment, the distance sensor 220 is placed at the top edge of mobile communications device 200. For measurement any kind of obstacle or target is needed at one end perpendicular to length to be measured. The total distance is calculated by keeping the mobile communications device 200 at one end of the distance to be measured. For measuring the length of room, the mobile communications device 200 is kept flat against one wall. An opposite wall will act as the target and reflect the generated signal.

To measure the height of a person, the mobile communications device is held vertical at the top head level of a standing person. The ground will act as the target at the other end. To measure the length of table, there is need of a vertical obstacle/surface at one end of table with the mobile communications device 200 being positioned at the opposite end.

The mobile communications device disclosed herein provides a handy distance measurement tool that can be used for many uses. With it, an external hardware device is not needed for taking measurements. The mobile communications device is easily accessible and can easily be used to determine a distance in mere seconds. Advantageously, the mobile communications device can make measurements over a large range from millimeters to around 100 meter with good accuracy. Thus a single tool can be used for various types of measurements. Distance can also be measured in air/space and no need of any direct surface between two ends.

FIG. 3 illustrates a flow diagram of an embodiment of a method of manufacturing a mobile communications device carried out according to the principles of the disclosure. The method 300 begins in a step 305.

In a step 310, a distance sensor is connected to a body of the mobile communications device. In one embodiment, all or substantially all of the distance sensor is placed within the body. The distance sensor can mechanically fixed to the body via a conventional means. The distance sensor can be a laser sensor. In some embodiments the distance sensor is an ultrasonic sensor. The distance sensor can be positioned proximate an edge of the body. In some embodiments, the distance sensor is placed on a side of the body that is opposite a display thereof.

In a step 320, a communications interface is connected to the body. The communications interface can include an antenna and associated circuitry that is placed within the body of the mobile communications device.

A processor is also connected to the body in a step 330. The processor can be placed within the body or at least a top or bottom portion of the body.

In a step 340, the processor is connected to the distance sensor and the communications interface. Conventional connections and conductors can be used to electrically connect the processor to the distance sensor and the communications circuitry to allow communication therebetween. In some embodiments, a communications bus can be used.

In a step 350, a memory is connected to the processor. The memory can also be connected to the body. Additionally, a display is connected to the body in a step 360. The display can also be connected to the processor. In a step 370, a microphone and a speaker are connected to the body. In a step 380, the method ends.

A portion of the above-described apparatuses, systems or methods of measuring may be embodied in or performed by various processors, such as conventional digital data processors or computing devices, wherein the processors are programmed or employ stored executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computing devices to perform one, multiple or all of the steps of one or more of the above-described methods of measuring, or functions of the apparatuses described herein. As discussed with respect to disclosed embodiments, a mobile communications device such as a smart phone can include the necessary hardware, software or a combination thereof that is configured to perform the described functions.

Portions of disclosed embodiments may relate to computer storage products with a non-transitory computer-readable medium that have program code thereon for performing various computer-implemented operations that embody a part of an apparatus, system or carry out the steps of a method of measuring as set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A mobile communications device, comprising:
a communications interface configured to transmit and receive data according to a communications protocol;
a processor configured to direct communication of said data employing said communications interface; and
a distance sensor configured to determine a distance between two objects, wherein said processor is further configured to direct operation of said distance sensor.

2. The mobile communications device of claim 1 further comprising a display configured to visually represent said distance.

3. The mobile communications device of claim 1 further comprising a memory having stored thereon a measurement application configured to employ said distance sensor to determine multiple distances.

4. The mobile communications device of claim 3 wherein said measurement application is configured to employ said multiple distances in geometric calculations.

5. The mobile communications device of claim 1 further comprising a user input interface configured to receive input to direct operation of said distance sensor.

6. The mobile communications device of claim 1 further comprising a speaker configured to audibly indicate said distance.

7. The mobile communications device of claim 1 wherein said distance sensor is a laser sensor.

8. A method of manufacturing a mobile communications device, comprising:
connecting at least a portion of a distance sensor to a body of said mobile communications device;
connecting at least a portion of a communications interface to said body; and
connecting said distance sensor and said communications interface to a processor of said mobile communications device.

9. The method as recited in claim 8 further comprising connecting a memory to said processor.

10. The method as recited in claim 8 wherein said distance sensor is a laser sensor.

11. The method as recited in claim 8 wherein said distance sensor is an ultrasonic sensor.

12. The method as recited in claim 8 wherein said distance sensor is positioned proximate an edge of said body.

13. The method as recited in claim 8 further comprising connecting a display to said body, wherein said distance sensor is placed on a side of said body opposite said display.

14. The method as recited in claim 8 further comprising connecting a microphone and a speaker to said body, wherein said distance sensor is configured audibly communication with a user through said microphone and said speaker.

15. A smart phone, comprising:
a body;
a communications interface connected to said body; and
a distance sensor connected to said body.

16. The smart phone as recited in claim 15 wherein said distance sensor is a dedicated measuring tool.

17. The smart phone as recited in claim 15 wherein said communications interface is configured to communicate over a cellular network.

18. The smart phone as recited in claim 15 further comprising a camera, wherein said distance sensor is positioned proximate said camera.

19. The smart phone as recited in claim 15 further comprising a processor and a memory, wherein said memory includes a measurement application configured to employ said distance sensor.

20. The smart phone as recited in claim 15 wherein said distance sensor is a laser sensor having a originating laser transducer and a terminating laser transducer, wherein said originating laser transducer is configured to transmit a measuring signal for determining a distance and said terminating laser transducer is configured to receive a reflection of said measuring signal for determining said distance.
